(19) United States
(12) Patent Application Publication
(10) Pub. No.: US 2026/0210764 A1
(43) Pub. Date: Jul. 23, 2026

(54) SERRODYNE FREQUENCY SHIFT SPECTROMETER AND SERRODYNE FREQUENCY SHIFTING

(71) Applicant: Government of the United States of America, as represented by the Secretary of Commerce, Gaithersburg, MD (US)

(72) Inventors: David Alexander Long, Bethesda, MD (US); Sean Michael Bresler, Washington, DC (US); Benjamin James Reschovsky, Cabin John, MD (US); John Russell Lawall, Bethesda, MD (US)

(21) Appl. No.: 19/139,677

(22) PCT Filed: Dec. 18, 2023
(86) PCT No.: PCT/US2023/084597

§ 371 Date: Jun. 16, 2025

Related U.S. Application Data
(60) Provisional application No. 63/433,091, filed on Dec. 16, 2022.

(51) Int. Cl. G01J 3/45; G01J 3/10

(52) U.S. Cl. CPC G01J 3/45; G01J 3/10

(57) ABSTRACT

A frequency comb spectrometer with serrodyne shift includes a light source; and an interferometer configured to accept light from the light source, wherein the interferometer has a comb generating portion, a serrodyne generating portion configured to shift a frequency of the light from the light source using a serrodyne modulation technique, and a combining portion configured to combine output from the comb generating portion and the serrodyne generating portion.

### RELATED APPLICATIONS

This application claims the benefit of U.S. Provisional Patent Application Ser. No. 63/433,091 (filed Dec. 16, 2022), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to comb spectroscopy, and more particularly to comb spectroscopy using serrodyne shift.

### BACKGROUND

Optical frequency combs are specialized lasers that act like a ruler for light. They measure exact frequencies of light—from the invisible infrared and ultraviolet to visible red, yellow, green and blue light—quickly and accurately. Optical frequency combs allow scientists to measure and control light waves as if they were radio waves. With optical frequency combs, technologies that employ radio and microwave frequencies-such as clocks, computers and communications—are now seamlessly connected to optical waves that oscillate at 10,000 times higher frequencies.

Optical frequency combs have been revolutionary for atomic clocks and timekeeping. Optical atomic clocks mark the passage of time by counting the natural oscillation of atoms in the same way a grandfather clock counts the swings of a pendulum. These atoms oscillate about 500,000 billion times a second—a much higher frequency than standard microwave-based atomic clocks. The current electronic systems that are used to measure frequency for microwave-based atomic clocks simply can't count the optical “ticks.”

Because the teeth of an optical frequency comb are evenly spaced and precise, the comb acts like the gears of a clock, taking the faster optical frequencies and dividing them down to the lower-frequency microwave signals used by electronics and current atomic clocks. This lets scientists link optical atomic clocks' higher-frequency “ticks” to microwave-based clocks' lower-frequency “ticks” and electronics used by present day computers and communications systems.

With these “gears” carrying accurate signals between electronics, microwave-based tools and optical atomic clocks, scientists can use these powerful new clocks for faster, more accurate timekeeping systems. Advanced optical atomic clocks also allow scientists to study the constants of nature beyond our own planet. For example, with the help of optical frequency combs, these improved clocks are used to search for elusive dark matter.

Optical frequency combs also are helping scientists search for exoplanets around distant stars. By tracking the exact colors of light from these stars, they can look for a wobble in the motion of a star that would indicate the presence of an Earth-like planet orbiting the star.

Optical frequency combs work over long distances. Lidar is a light detecting and ranging system that utilizes optical frequency combs to measure the distance to an object by analyzing light reflected from it. Frequency combs have been used to “see” through flames and identify melting objects. Frequency comb-based lidar has also been used to create 3D maps. Eventually, lidar using optical frequency combs could keep satellites and other space instruments flying in tight formations, acting as a single instrument.

Atoms and molecules can be identified by which frequencies of light they absorb. Since optical frequency combs generate millions of frequencies in short pulses, they can be used to quickly and efficiently study the quantity, structure, and dynamics of various molecules and atoms. This has many potential applications and is already being used to study short-lived molecules that link burning fossil fuels to air pollution. The structure and dynamics of large and complex molecules can also be probed by frequency combs such as detecting trace amounts of various molecules in gases.

Frequency combs measure an unknown optical frequency by measuring the repetition rate of a continuous train of light pulses-which lies in the larger, easy-to-measure radio frequency range. Optical frequency combs emit a continuous train of very brief, closely spaced pulses of light containing a million different colors, spanning from the invisible infrared through the visible and into the ultraviolet spectrum. Because of a technique called “mode locking,” all of the frequencies in each pulse start in phase, in sync with each other. The result resembles the teeth of a comb, separating each frequency into a distinct spike-hence the name of the device. The spacing of those teeth is very fine and exactly even, and they act like ticks on a ruler to measure light emitted by stars, atoms, other lasers, etc. with extreme precision and accuracy.

Optical frequency combs can be generated in a variety of methods including the use of pulsed lasers and through electro-optic modulation of a continuous wave laser. So-called electro-optic combs can be produced either by applying a high power single frequency tone to a modulator or through the use of more complex waveforms. The measurement of optical resonance frequencies of cavity modes is essential in almost all experiments with cavity optomechanical systems and is generally achieved using an optical readout method based on laser frequency locking. These measurements are used to determine the displacement of mechanical resonators, to determine changes in a cavity's effective refractive index, and to investigate dispersive or dissipative optomechanical interactions. While laser frequency locking is widely used for laser stabilization in macroscopic systems, it is less effective for the readout of micro- or nanoscale cavity optomechanical systems. Changes in cavity length due to the motion of an optomechanical resonator can cause frequency shifts that are large compared to the cavity linewidth, requiring wide frequency tuning of the locked laser. In addition, this frequency tuning must have high bandwidth in many cases in order to maintain the lock, such as when the optomechanical resonator has both high vibration amplitude and a high resonance frequency.

The combination of wide frequency tuning and high tuning bandwidth is not found in most stable single-frequency lasers. For example, external cavity diode lasers (ECDLs) may have sufficient tuning range, but the piezoelectric actuators used to tune the wavelength typically have bandwidths well below the mechanical resonance frequencies found in many cavity optomechanical systems. Also, although current tuning can provide high bandwidth in these lasers, it offers insufficient tuning range.

In certain circumstances, fast Pound-Drever-Hall (PDH) laser locking with large tuning ranges can be achieved using external modulators, but these techniques have other challenges, such as the presence of extraneous sidebands or the need for precise stabilization of multiple bias voltages. In addition, the high-gain, large-bandwidth controllers that are required amplify electronic noise over a large frequency band and contribute to readout noise. Finally, the broad linewidths of microcavity optical resonances (generally hundreds of MHz or more) require large modulation frequencies, adding to the challenges of PDH locking.

Given these limitations in laser technology, optical cavity readout with laser frequency locking generally results in low feedback bandwidth or low laser tuning range, or both. This is particularly problematic for optomechanical sensors, where large range and bandwidth are essential for operation, so new readout methods that can meet these performance requirements are essential.

An optical frequency comb generated with an electro-optic phase modulator can be used to detect the full spectrum of a single resonance of an optical cavity within an optomechanical system, and does not require laser locking, feedback control, or precision frequency tuning of the laser. By sampling this spectrum at a high rate, the center frequency of the cavity resonance can be measured as a function of time, thereby providing the change in length of the cavity. Also, this method avoids the complexity and added controller noise of a fast-feedback system. Finally, very high dynamic range can be achieved by generating a wide frequency comb, and the measurement range is limited only by the data acquisition and photodetector bandwidth, which can easily reach many GHz or more.

### SUMMARY OF INVENTION

Self-heterodyne and multiheterodyne spectroscopy are two different approaches to down convert an optical frequency comb to the radiofrequency domain for digitization and analysis. This can involve an acousto-optic modulator to provide a frequency shift between the two legs of the interferometer. Acousto-optic modulators are relatively expensive and narrow bandwidth. In addition, they can be difficult to fabricate in integrated photonics platforms.

Therefore, exemplary systems and methods use serrodyne modulation (i.e., using a sawtooth waveform to produce a linear phase chirp) with an electro-optic phase modulator to provide the needed frequency shift. This removes the need for an acousto-optic modulator in self-heterodyne and multiheterodyne experiments as well as dramatically increasing the available bandwidth for this modulation. This can be used in chip-scale, integrated platforms. Optical frequency comb (OFC) down-conversion by serrodyne modulation using an electro-optic phase modulator can be performed at reduced cost and instrumental complexity, and simultaneously provides a larger available bandwidth advantageous for chip-scale, integrated platforms, including photonics.

According to one aspect of the invention a frequency comb spectrometer with serrodyne shift includes a light source; and an interferometer configured to accept light from the light source, wherein the interferometer has a comb generating portion, a serrodyne generating portion configured to shift a frequency of the light from the light source using a serrodyne modulation technique, and a combining portion configured to combine output from the comb generating portion and the serrodyne generating portion.

Optionally, the comb generating portion of the interferometer includes a first optical path having a first electro-optic modulator driven electrically by a signal from a radiofrequency comb generator and wherein the serrodyne generating portion of the interferometer includes a second electro-optic modulator driven by a saw-tooth signal from a signal generator.

Optionally, the interferometer comprises a dual-drive Mach-Zehnder Modulator (DD-MZM).

Optionally, the interferometer comprises a single electro-optic modulator and an electrical signal combiner configured to combine an RF comb signal and a sawtooth signal into a combined signal and send it to the single electro-optic modulator.

Optionally, the comb generating portion drives a first electro-optic modulator and the interferometer includes a second comb generating portion, and wherein the second comb generating portion and the serrodyne generating portion together drive a second electro-optic modulator and the combining portion is configured to combine output from the first and second electro-optic modulators.

The foregoing and other features of the invention are hereinafter described in greater detail with reference to the accompanying drawings.

### BRIEF DESCRIPTION OF THE DRAWINGS

FIG. 1 shows a schematic diagram of an exemplary single-comb spectrometer with serrodyne shift.

FIG. 2 shows a schematic diagram of an exemplary single-comb spectrometer with serrodyne shift using a dual-drive Mach-Zehnder Modulator.

FIG. 3 shows a schematic diagram of an exemplary single-comb spectrometer with serrodyne shift using a single electro-optic modulator.

FIG. 4 shows a schematic diagram of an exemplary double-comb spectrometer with serrodyne shift.

### DETAILED DESCRIPTION

Direct multiheterodyne or self-heterodyne frequency comb spectroscopy commonly relies upon the use of an acousto-optic modulator to provide a frequency shift of the resulting radiofrequency interferogram. Serrodyne modulation can provide this shift, resulting in a significant reduction of instrumental complexity and cost while also providing a simpler path to chip-scale integrated photonics.

Serrodyne modulation (i.e., using a sawtooth waveform to produce a linear phase chirp) is performed using an electro-optic phase modulator to provide the needed frequency shift. This removes the need for an acousto-optic modulator in self-heterodyne and multiheterodyne experiments as well as dramatically increasing the available bandwidth for this modulation. This can be used in chip-scale, integrated platforms.

Further, an all-electro-optic modulator based approach can include a single dual-drive Mach-Zehnder modulator to produce the comb(s) and frequency shift. This provides for a full multiheterodyne or self-heterodyne spectrometer in a single modulator that can operate over a wide bandwith without requiring radio-frequency instrumentation.

Exemplary methods, therefore, lower costs by removing a series of fiber optic splitters and individual modulators. In addition, the noise is lower given the strong common-mode nature of the comb generation and the reduction of overall fiber length and number of components. This provides comb generation and operation in a chip-scale package. Additionally, this approach reduces cost and complexity by reducing output signals to frequencies well below radiofrequencies (10 GHZ) so that cost-effective components and data acquisition tools may be used.

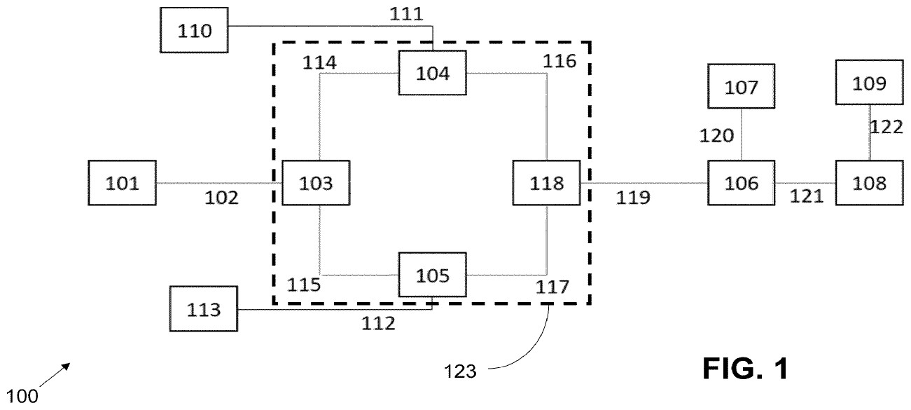

Turning to FIG. 1, an exemplary single-comb spectrometer 100 with serrodyne shift is illustrated in schematic form. Single-frequency light may be generated by a laser 101 and communicated by an optical path 102 to an optical beamsplitter 103. The optical path could be in free space, in an optical fiber, or in an optical waveguide on a photonic integrated circuit (PIC), for example. The light exits the beamsplitter in two directions. The upper arm 114 goes to an electro-optic modulator (EOM) 104. The EOM may be driven electrically by a signal 111 from a radiofrequency (RF) generator 110 and creates an optical frequency comb at the output of the EOM 104. The lower arm 115 goes to a second EOM 105. The EOM 105 may be driven by a saw-tooth (or serrodyne) signal 112 from signal generator 113, which shifts the frequency of the light at the output of the EOM by the serrodyne modulation technique. The outputs 116, 117 of the EOMs 104, 105 are combined at another beamsplitter 118 and the combined beam 119 is directed either directly to a device under test or to a beamsplitter 106 to split the beam and then to the device under test 107 via path 120. The light probes the device under test 107 and is also sent via the optical circulator or beamsplitter 106 on another optical path 121 to a photodetector 108. The electrical output 122 of the photodetector 108 may be sent to a digitizer 109 where it may be recorded and then analyzed to show the optical spectrum of the device under test 107.

Optionally, there may be some situations where the device under test 107 may be located on the comb leg 116, and the output of the device under test 107 is combined at beamsplitter 118 with the output 117.

When driving an EOM using a high-fidelity sawtooth waveform with a peak-to-peak amplitude that corresponds to a 2π phase shift, the input optical beam experiences a frequency shift given by the repetition rate of the sawtooth.

To model the modified laser frequency caused by periodic sawtooth phase modulation, we consider a laser field \tilde{E}(t)=e^{i(2f}^{₀}^{t)} having a carrier frequency f₀ and unity amplitude. Upon phase modulation Δφₘ(t), the time-dependent field becomes e^{i(2πf}^{₀}^{t+Δφ}^{ₘ}^{(t))} with a power spectrum given by P (f)=|F {e^{i(2πf}^{₀}^{t+Δφ}^{ₘ}^{(t)}}/2, where F and f are the fast-Fourier transform operator and Fourier frequency, respectively.

Denoting the repetition rate and period of the phase modulation by fᵣ and

$${T}_{r} = {f}_{r}^{- 1} ,$$

respectively, a single cycle of the waveform is calculated as Δφₘ(t)=2Δφₐ(fᵣtβ−½) over the time interval 0≤t<βTᵣ, and Δφₘ(t)=2Δφₘ(t)=2Δₐ[½−fᵣ(t−βTᵣ)/(1−β)] for βTᵣ≤t<Tᵣ. Here Δφₐ is half the peak-to-peak modulation amplitude (a constant), and β is an asymmetry factor, which when equal to zero or ½ gives an ideal sawtooth or a triangle wave, respectively. When β is slightly greater than zero, one can consider the effect of small deviations from an ideal sawtooth. Based on this analysis, the shape of the power spectrum is a function of f and varies parametrically with Δφₐ and β. More detail on these calculations and experimental data can be found in D. A. Long, et al., “Single-modulator, direct frequency comb spectroscopy via serrodyne modulation,” Opt. Lett. 48, 892-895 (2023), the contents of which are herein incorporated by reference in their entirety.

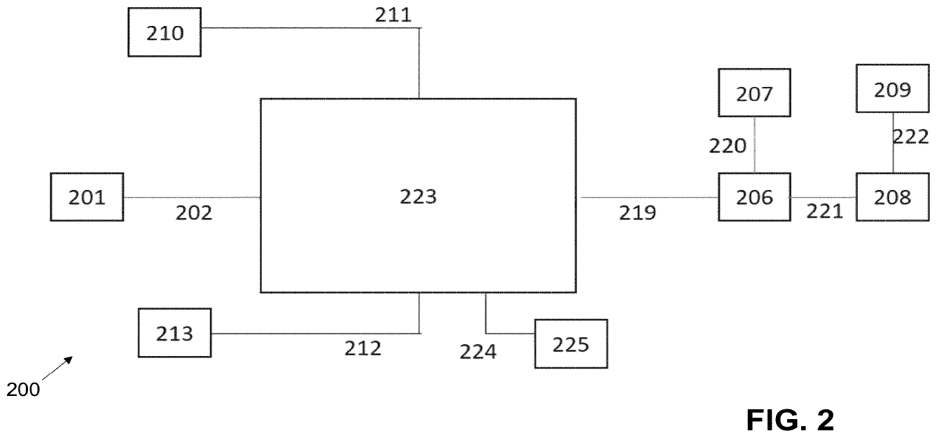

Turning now to FIG. 2, an exemplary embodiment of the single-comb spectrometer is shown at 200 with serrodyne shift using a dual-drive Mach-Zehnder Modulator (DD-MZM). The single-comb spectrometer 200 is substantially the same as the above-referenced single-comb spectrometer 100, and consequently the same reference numerals but indexed by 100 are used to denote structures corresponding to similar structures in the single-comb spectrometer. In addition, the foregoing description of the single-comb spectrometer 100 is equally applicable to the single-comb spectrometer 200 except as noted below. Moreover, it will be appreciated upon reading and understanding the specification that aspects of the single-comb spectrometers may be substituted for one another or used in conjunction with one another where applicable.

This spectrometer 200 functions nearly identically to the one above, however, the entire interferometer section 123 is replaced by a dual-drive Mach-Zehnder Modulator (DD-MZM) 223, which is a single-device that includes all the features of the interferometer 123 shown in the previous figure. In this case there is an additional DC voltage signal 224 (generated by DC voltage supply 225) that sets the overall phase between the two arms of the interferometer.

This embodiment removes the need for bulk beamsplitters and the additional modulator. In addition to the lower system cost and complexity, this approach greatly reduces phase noise in the system by reducing the length of non-common paths within the interferometer.

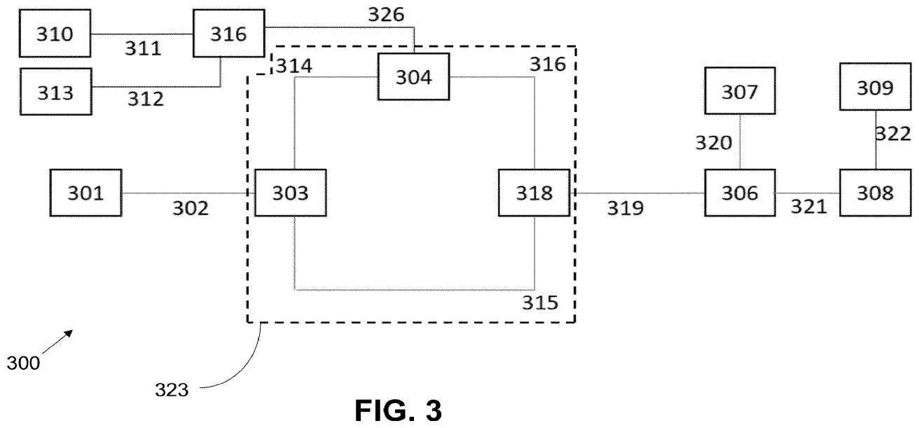

Turning now to FIG. 3, an exemplary embodiment of the single-comb spectrometer is shown at 300 with serrodyne shift using a single EOM. The single-comb spectrometer 300 is substantially the same as the above-referenced single-comb spectrometers 100, 200 and consequently the same reference numerals but indexed by 100 are used to denote structures corresponding to similar structures in the single-comb spectrometer. In addition, the foregoing descriptions of the single-comb spectrometers 100, 200 are equally applicable to the single-comb spectrometer 300 except as noted below. Moreover, it will be appreciated upon reading and understanding the specification that aspects of the single-comb spectrometers may be substituted for one another or used in conjunction with one another where applicable.

This spectrometer 300 functions nearly identically to the ones above, however it uses just a single optical modulator 304. Since it does not matter which arm of the interferometer 323 the frequency shift is performed upon, the same EOM 304 can be used to perform the serrodyne frequency shift and generate the optical frequency comb. In this case, the RF comb signal 311 from RF comb generator 310 and the sawtooth signal 312 from sawtooth signal generator 313 are combined electrically by electrical signal combiner 316 into combined signal 326 before being sent to the EOM 304. Another way of generating the combined electrical signal would be to sum them digitally and then generate the summed signal directly by a digital-to-analog-converter (DAC).

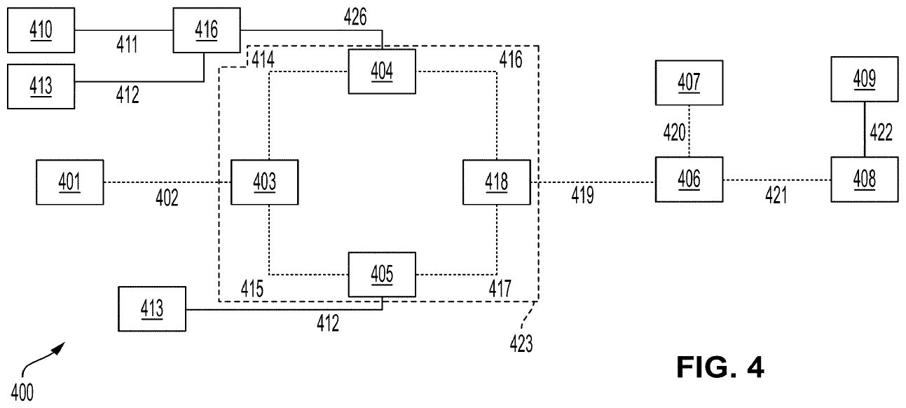

Turning now to FIG. 4, an exemplary embodiment of a dual-comb spectrometer is shown at 400 with serrodyne shift. The dual-comb spectrometer 400 is substantially the same as the above-referenced single-comb spectrometers 100, 200, 300 and consequently the same reference numerals but indexed by 100 are used to denote structures corresponding to similar structures in the spectrometer. In addition, the foregoing descriptions of the single-comb spectrometers 100, 200, 300 are equally applicable to the dual-comb spectrometer 400 except as noted below. Moreover, it will be appreciated upon reading and understanding the specification that aspects of the spectrometers may be substituted for one another or used in conjunction with one another where applicable.

In a dual-comb spectrometer 400, two slightly different optical frequency combs 416, 417 are generated in the two arms of the interferometer 423. For this kind of device, a constant frequency shift is also required between the two arms of the interferometer 423, which can also be accomplished with serrodyne modulation. In this figure, the upper EOM 404 is driven by a combined sawtooth plus comb signal 426. The lower EOM 405 is driven by a second comb signal 412 from an RF comb generator 413. It is worth noting that the configuration shown in FIG. 2 could also be done in a dual comb configuration (i.e. sum a comb signal with the serrodyne signal to be applied to one side of the modulator).

Recent advancements in thin-film lithium niobate (TFLN) technology have enabled the development of compact on-chip electro-optic modulators (EOMs) with >100 GHz modulation bandwidth and half-wave voltages, V_{π}, which outperform traditional bulk lithium niobate EOMs. When electro-optic frequency comb spectroscopy is integrated with on-chip EOMs, it becomes a scalable platform for multiplexed solid-state on-chip spectroscopy. However, these previous integrated electro-optic comb generation approaches have relied upon high radiofrequency drive powers between 0.3 W to 4 W (25 dBm to 36 dBm), which restrict their application in field-deployable platforms. Here we present an on-chip integrated spectrometer that allows for frequency-agile, electro-optic frequency combs generated by ultralow power radiofrequency waveforms (25 nW to 4 mW, i.e., −46 dBm to 6 dBm) which are readily compatible with even the lowest available on-chip powers. More details may be found in Long, D. A. et al. Agile chip-scale electro-optic frequency comb spectrometer with millivolt drive voltages. arXiv: 2309.07713 [physics.optics] (2023), the contents of which are hereby incorporated herein in its entirety.

Further, the fabrication approach presented herein allows for compatibility with a wide range of sensors based on silicon nitride PICs on the same chip as well as off-chip sensors. As a result, we have concurrently probed a temperature sensor integrated on the same chip as the electro-optic modulators as well as a separate fiber-connectorized chip-scale optomechanical accelerometer. With both sensors we achieve state-of-the-art performance with temperature and acceleration sensitivities of ≈5 μK·Hz^{-1/2} and ≈130 μm·s⁻²·Hz^{-1/2} (≈13 μg/Hz^{1/2}, where 1 g=9.80665 m/s²), respectively, demonstrating the power of the integrated, frequency-agile optical frequency comb spectrometer.

An exemplary TFLN-based electro-optic frequency comb spectrometer may be composed of a Mach-Zehnder interferometer (MZI) with an electro-optic phase modulator on each leg. The light from the lensed fiber may be coupled to the input waveguide, consisting of a silicon nitride ridge waveguide with a width of ≈2500 nm and a lithium niobate slab layer vertically spaced by ≈100 nm. The input light is divided into two arms by a multi-mode interference 1×2 splitter. The waveguide width becomes narrower (≈650 nm) after the splitter to efficiently modulate the phases by expanding the mode into the lithium niobate layer. The electro-optic modulator in the lower arm is driven by a chirped waveform to generate the electro-optic frequency comb, while the upper modulator receives a serrodyne modulation to generate a frequency-shifted local oscillator for heterodyne detection. The frequency comb signal is first used to interrogate the on-chip silicon nitride racetrack resonator, which acts as a temperature sensor. Subsequently the optical signals are combined via a symmetric 2×2 directional coupler and sent via an output optical fiber to probe the Fabry-Pérot optical cavity of the physically separate chip-scale optomechanical accelerometer before being detected.

The optical waveguides are fabricated from stoichiometric silicon nitride with a thickness of ≈350 nm. All features are patterned by 365 nm ultraviolet stepper lithography to allow for low-cost mass-production. A ≈300 nm thick, X-cut TFLN layer is bonded on top of the waveguide with an ≈100 nm silicon dioxide gap. Approximately 4 cm² TFLN squares are bonded to the PIC wafer via direct bonding of lithium niobate on insulator chips with subsequent Si handle layer removal by mechanical polishing and reactive ion etching. The TFLN layer is bonded selectively where active phase modulation is required.

In order to down-convert the optical frequency comb into the radiofrequency domain for digitization via self-heterodyne detection, a local oscillator (LO) that is frequency shifted with respect to the initial laser frequency may be used. This frequency shift translates the center of the radiofrequency comb away from DC and ensures that the comb teeth occur at unique radiofrequencies. Conventionally in fiber-optic comb systems this LO frequency shift is achieved with an acousto-optic modulator (AOM). However, while integrated acousto-optic modulators based on TFLN have been demonstrated, the complexity of incorporating acousto-optic devices onto the same platform as our on-chip EOMs and temperature sensors-without degrading the performance of any element-suggests that a pure electro-optic approach would be advantageous. As a result, here we have utilized serrodyne electro-optic phase modulation to produce the required frequency shift. Serrodyne modulation may be produced by a 600 kHz sawtooth waveform from a commercial function generator. We note that this benchtop function generator could be replaced by more compact solutions such as commercially available, chipbased function generators without deviating from the scope of the invention.

After the optical frequency comb has probed the evanescently coupled racetrack microresonator, it may be combined with the serrodyne-shifted LO by a 2×2 directional coupler. A lensed fiber may be employed to couple the light off chip. For the measurements in the absence of the optomechanical accelerometer, the optical power may be detected by a photodiode. The resulting interferogram may be digitized, Fourier transformed, and normalized, producing an optical frequency comb spectrum. An integrated resistive heater driven by a proportional-integral-derivative servo may be employed to control the chip's temperature. As the temperature of the chip is changed, the integrated optical frequency comb spectrometer may be readily able to measure the shift of the microresonator optical cavity mode, allowing for a direct measurement of the resonator's temperature. We note that exemplary noise floors lie below that of cutting-edge photonic thermometers.

Unlike laser locking approaches, exemplary integrated comb spectrometers presented herein provide full spectrum information for each measurement and can be used to dynamically extract features of the cavity mode shape, such as coupling efficiency and finesse for multiple devices simultaneously.

An exemplary fabrication method is given below, but is not meant to be limiting as to method of fabrication in any way. A stoichiometric silicon nitride layer with a nominal thickness of 350 nm may be deposited by low-pressure chemical vapor deposition (LPCVD) on top of a thermally oxidized silicon dioxide layer with a nominal thickness of 3 μm as a buried oxide layer (BOX). The waveguide may be patterned by a UV lithography stepper with a wavelength of 365 nm and reactive ion etching with a CF₄/O₂ gas mixture. After removing the photoresist with a piranha cleaning solution, a plasma-enhanced chemical vapor deposition (PECVD) tool may be used to deposit nominally 1 μm of silicon dioxide. The corrugated top surface of the wafer may be planarized by a chemical-mechanical polishing (CMP) tool, leaving ≈100 nm of silicon dioxide on top of the silicon nitride waveguide. Aluminum oxide layers (≈3 nm thickness) may be coated on both the silicon nitride waveguide wafer and the diced lithium niobate on insulator (LNOI) wafer. After a deionized wafer spray cleaning, the two samples may be held together for wafer bonding at room temperature and atmospheric pressure. The bonded wafer may be annealed at 200° C. for 1 hour to enhance the bonding strength. Next, a ≈3 μm thick silicon dioxide layer may be deposited by the PECVD tool to act as a protecting layer for the silicon nitride waveguide circuit in regions without the TFLN. The silicon substrate of the bonded LNOI piece may then be removed by mechanical polishing, leaving ≈50 μm of silicon, with the rest of the substrate removed by reactive ion-etching with SF₆. The BOX layer of the LNOI piece may be then thinned to ≈700 nm with a buffered oxide etcher. Gold electrode may be patterned with a direct laser writing tool to produce a nominal electrode gap of 3.5 μm. A double-layer metal lift-off may be used to define the gold electrodes with a nominal thickness of 900 nm. Finally, the edges of the sample may be mechanically polished for lensed fiber coupling to waveguides with polished end facets.

Exemplary serrodyne spectrometers can be made of various elements and components that are microfabricated. Elements of serrodyne spectrometers can be various sizes. Elements of serrodyne spectrometers can be made of a material that is physically or chemically resilient in an environment in which serrodyne spectrometer is disposed. Exemplary materials include a metal, ceramic, thermoplastic, glass, semiconductor, and the like. The elements of serrodyne spectrometers can be made of the same or different material and can be monolithic in a single physical body or can be separate members that are physically joined.

Exemplary serrodyne spectrometers can be made in various ways. It should be appreciated that serrodyne spectrometers include a number of optical, electrical, or mechanical components, wherein such components can be interconnected and placed in communication (e.g., optical communication, electrical communication, mechanical communication, and the like) by physical, chemical, optical, or free-space interconnects. The components can be disposed on mounts that can be disposed on a bulkhead for alignment or physical compartmentalization. As a result, serrodyne spectrometers can be disposed in a terrestrial environment or space environment.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

What is claimed is:

1. A frequency comb spectrometer with serrodyne shift comprising:
a light source; and
an interferometer configured to accept light from the light source, wherein the interferometer has a comb generating portion, a serrodyne generating portion configured to shift a frequency of the light from the light source using a serrodyne modulation technique, and a combining portion configured to combine output from the comb generating portion and the serrodyne generating portion.

2. The frequency comb spectrometer of claim 1, wherein the comb generating portion of the interferometer includes a first optical path having a first electro-optic modulator driven electrically by a signal from a radiofrequency comb generator and wherein the serrodyne generating portion of the interferometer includes a second electro-optic modulator driven by a saw-tooth signal from a signal generator.

3. The frequency comb spectrometer of claim 1, wherein the interferometer comprises a dual-drive Mach-Zehnder Modulator (DD-MZM).

4. The frequency comb spectrometer of claim 1, wherein the interferometer comprises a single electro-optic modulator and an electrical signal combiner configured to combine an RF comb signal and a sawtooth signal into a combined signal and send it to the single electro-optic modulator.

5. The frequency comb spectrometer of claim 1, wherein the comb generating portion drives a first electro-optic modulator and the interferometer includes a second comb generating portion, and wherein the second comb generating portion and the serrodyne generating portion together drive a second electro-optic modulator and the combining portion is configured to combine output from the first and second electro-optic modulators.
